(19) United States
(12) Patent Application Publication
(10) Pub. No.: US 2026/0162654 A1
(43) Pub. Date: Jun. 11, 2026

(54) MULTILINGUAL AUTOMATIC SPEECH RECOGNITION

(71) Applicant: NVIDIA Corporation, Santa Clara, CA (US)

(72) Inventors: Myungjong Kim, Milpitas, CA (US); Mayank Jain, Kota (IN); Yitagessu Gebremedhin, Aurora, CO (US); Utkarsh Vaidya, Jabalpur (IN); Oluwatobi Olabiyi, San Francisco, CA (US)

(21) Appl. No.: 18/973,850

(22) Filed: Dec. 9, 2024

(51) Int. Cl. G10L 15/19; G06F 40/58; G10L 15/00; G10L 15/06; G10L 15/187; G10L 15/30

(52) U.S. Cl. CPC G10L 15/19; G06F 40/58; G10L 15/005; G10L 15/063; G10L 15/187; G10L 15/30

(57) ABSTRACT

A textual transcript and one or more language indicators are determined using a multilingual speech-to-text (STT) model of a multilingual automatic speech recognition (ASR) system and using an audio sample as input to the multilingual STT model. The textual transcript is associated with the audio sample, and the one or more language indicators are each associated with a respective grammatical unit of one or more grammatical units of the textual transcript. A monolingual language model (LM) of a plurality of monolingual LMs of the ASR system is identified using a language indicator of the one or more language indicators. The textual transcript associated with the audio sample is caused to be refined using the identified LM and using a subset of the textual transcript as input to the identified LM.

### TECHNICAL FIELD

Aspects and embodiments of the present disclosure relate to automatic speech recognition, and in particular to multilingual automatic speech recognition pipelines using a multilingual speech-to-text model and language indicators.

### BACKGROUND

Automatic speech recognition often includes acoustic speech-to-text machine learning models that are trained to recognize a single language and transcribe streaming or recorded audio of that language into text. The text transcription generated by the speech-to-text model can be refined and enhanced using language models and other post-processing operations such as inverse text normalization.

### BRIEF DESCRIPTION OF THE DRAWINGS

Various embodiments in accordance with the present disclosure will be described with reference to the drawings, in which:

FIG. 1A is a block diagram of an example system architecture for a multilingual automatic speech recognition pipeline using a multilingual speech-to-text model and language indicators, in accordance with at least one embodiment;

FIG. 1B is a block diagram of an example architecture for multilingual STT model, in accordance with at least one embodiment;

FIG. 2 illustrates a multilingual STT training dataset generated from a plurality of monolingual STT training datasets, in accordance with at least one embodiment;

FIG. 3 illustrates a multilingual STT training dataset generated from a code-switching training dataset, in accordance with at least one embodiment;

FIG. 4 is a flow diagram of an example method for a multilingual automatic speech recognition pipeline using a multilingual speech-to-text model and language indicators, in accordance with at least one embodiment;

FIG. 5 is a block diagram of an example computing device, in accordance with at least one embodiment;

FIG. 6 illustrates an example data center, in accordance with at least one embodiment;

FIGS. 7A-7B illustrate inference and/or training logic used to perform inferencing and/or training operations, in accordance with at least one embodiment;

FIG. 8A is a block diagram of an example generative language model system, in accordance with at least one embodiment;

FIG. 8B is a block diagram of an example implementation in which a generative LM includes a transformer encoder-decoder, in accordance with at least one embodiment;

FIG. 8C is a block diagram of an example implementation in which a generative LM includes a decoder-only transformer architecture, in accordance with at least one embodiment;

FIG. 9 is a block diagram of a computing system having two processing devices coupled to each other and multiple networks, in accordance with at least one embodiment;

FIG. 10 is a block diagram of a computing system having a CPU and a GPU in a single integrated circuit, in accordance with at least one embodiment; and

FIG. 11 is a block diagram of a computing system having tensor core GPUs, in accordance with at least one embodiment.

### DETAILED DESCRIPTION

Aspects of the present disclosure relate to multilingual automatic speech recognition and transcription. Monolingual automatic speech recognition (ASR) often includes acoustic speech-to-text machine learning models (STT models) that are trained to recognize a single language and transcribe streaming or recorded audio of that language into text. Thus, the language being transcribed should be known beforehand to select an appropriate monolingual STT model. The text transcription generated by the STT model can be refined and enhanced using language models (LMs) and other post-processing operations such as inverse text normalization (ITN, which can be rule-based or model-based). LMs and ITN can also be language specific.

Multilingual ASR has the potential to provide several benefits over monolingual ASR techniques like those described above. Multilingual ASR can use fewer models to recognize and transcribe speech in multiple languages, which can reduce the need to train and manage multiple STT models or LMs and can reduce the need to identify the spoken language beforehand. Multilingual ASR can also support code switching (e.g., alternating between two or more languages within an audio sample). However, multilingual ASR faces additional challenges. Multilingual LMs and ITN can be inefficient due to the size of these models. Furthermore, training multilingual LMs is complicated by the unbalanced availability of training data across different languages (e.g., English may have more available training data than some other languages). This can lead to poor performance for some languages, which can be difficult and time-consuming to mitigate with advanced data augmentation and balancing techniques. Multilingual STT models and LMs can have different architectures and training parameters than equivalent monolingual models, which can further complicate the training process and prevent reuse of existing training infrastructure.

Aspects of the present disclosure address these and other challenges by providing a multilingual ASR pipeline that includes a multilingual STT model and a plurality of monolingual LM models, as well as monolingual ITN and other post-processing components. The multilingual STT model can be trained to recognize and transcribe multiple languages into text. The multilingual STT model can further be trained to label the transcribed text with the relevant language using language indicators. The language indicators can be placed in the transcription in association with individual grammatical units, such as paragraphs, sentences, words, morphemes, graphemes, etc. For example, a language token <en-US> can be placed at the end of a transcribed sentence recognized as US English.

In at least one embodiment, a multilingual STT model can use the same or similar model architecture, loss function, and other training components as a monolingual STT because the language indicators can be part of the model's vocabulary. A multilingual STT model can be trained on a multilingual training dataset that includes relevant language indicators at appropriate positions (e.g., at the ends of sentences). Monolingual training datasets can be modified to include these indicators. Thus, a multilingual STT model can provide the benefits of fewer models and automatic language identification while retaining the architecture and training benefits of monolingual STT models.

In at least one embodiment, once a multilingual STT model has transcribed speech to text and inserted language indicators, a multilingual ASR system can use the language indicator(s) to select an appropriate monolingual LM and other relevant monolingual post-processing operations such as ITN. The multilingual ASR system can proceed to refine and enhance the transcription using the selected monolingual components. Thus, a multilingual ASR system can retain the benefits of smaller post-processing models associated with a monolingual approach, as well as the benefits associated with training LMs separately due to imbalanced training data.

In at least one embodiment, a multilingual ASR system with a multilingual STT model and monolingual post-processing components can further support code switching (when a speaker alternates between two or more languages in conversation). A multilingual STT model can be trained to place two (or more) language indicators with sentences or other grammatical units that contain code switching. In the post-processing stage, an available bilingual LM can be used to process the code switching, or monolingual LMs can be mixed to process the code switching.

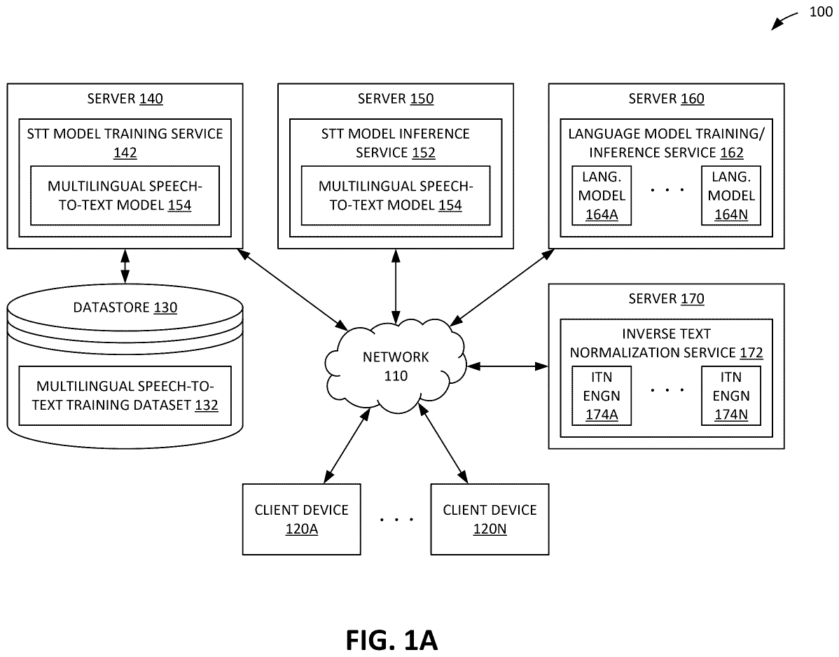

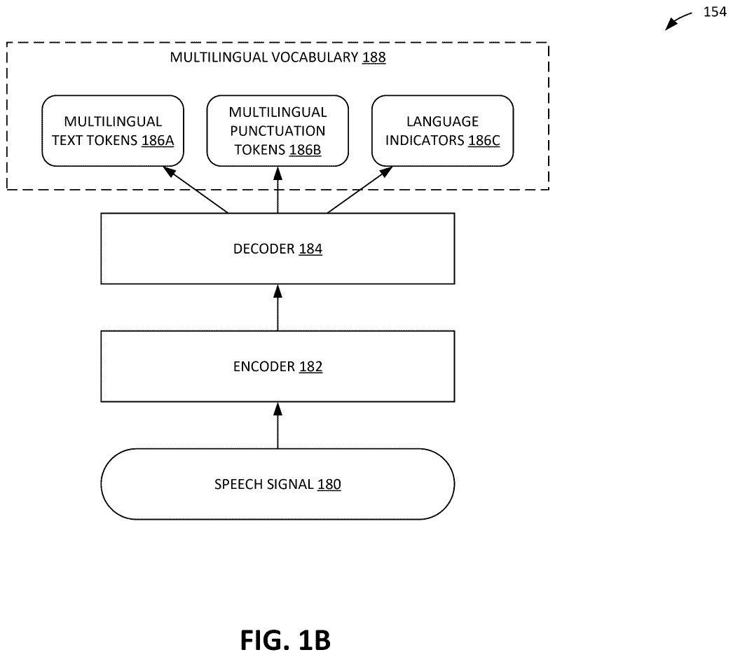

FIG. 1A is a block diagram of an example system architecture 100 for a multilingual automatic speech recognition pipeline using a multilingual speech-to-text model and language indicators, in accordance with at least one embodiment. System architecture 100 (also referred to as “system” herein) includes network 110, client devices 120A-120N, datastore 130, and servers 140-170. In various embodiments, system 100 can include more or fewer components in different configurations than those depicted in FIG. 1A. For example, system 100 can include additional servers, networks, etc. In another example, servers 140-170 can be combined.

Network 110 can include a public network (e.g., the Internet), a private network (e.g., a LAN, a WAN, a VPN, an enterprise network), a wired network (e.g., Ethernet), a wireless network (e.g., an 802.11 Wi-Fi network), a cellular network (e.g., a 5G network), routers, hubs, switches, server computers, or a combination thereof. Network 110 or components thereof can be associated with different organizations in various embodiments. For example, components of network 110 can be associated with Internet Service Providers (ISPs), mobile or cellular carriers, cloud platform or software-as-a-service (SaaS) providers, private or public enterprises, private households or communities, etc. In at least one embodiment, network 110 (or a component thereof) can be a physical or virtual interconnect within a single device, such as a PCIe bus, a messaging system, or an API.

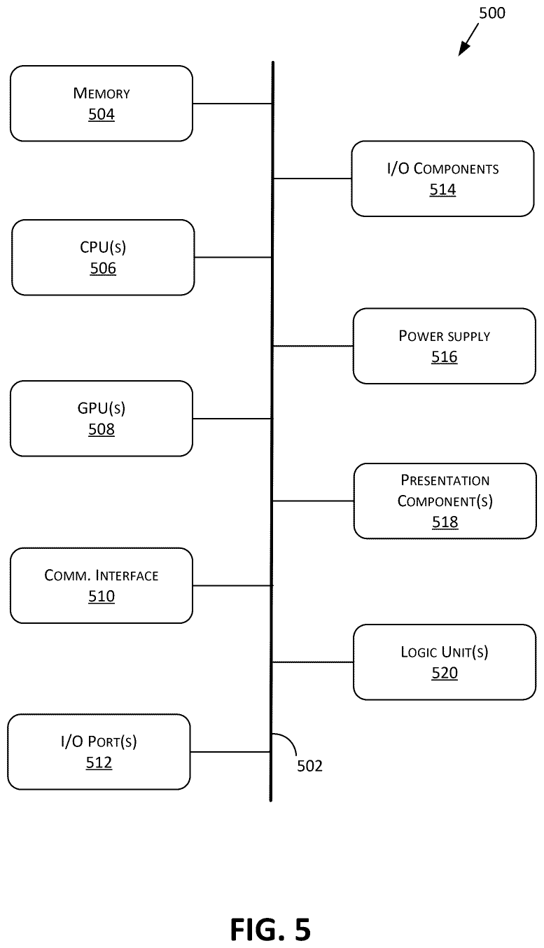

Client devices 120A-120N can be personal computers (PCs), laptops, notebook computers, mobile phones, smartphones, tablet computers, digital assistants, network-connected televisions (e.g., smart TVs), handheld gaming devices, gaming consoles, or any other computing devices. The computer system of FIG. 5 can be an example of a client device. In various embodiments, client devices 120A-120N can also be referred to as “user devices.” Client devices 120A-120N can run an operating system (OS) that manages hardware and software of the client devices. Client devices 120A-120N can further include a web browser, application, or other software for interacting with servers 140-170. Client devices 120A-120N can be used by users for initiating ASR processes (e.g., training and/or inference) on servers 140-170. In general, and as described herein, functions described in embodiments as being performed by servers 140-170 can also or alternatively be performed on client devices 120A-120N in other embodiments. For example, ASR inference can be performed on client devices 120A-120N in at least one embodiment. In addition, the functionality attributed to a particular component can be performed by different or multiple components operating together.

Datastore 130 can be an application for receiving, storing, and providing data. Datastore 130 can be a relational or non-relational database, structured or unstructured database, key-value store, filesystem, or can conform to other data storage classifications. Datastore 130 can be backed by various persistent or non-persistent storage devices, such as RAM, magnetic tapes or drives, solid-state drives, optical drives, or similar (e.g., other storage technologies discussed below with reference to FIG. 5). Datastore 130 can also include storage devices in a networked topology, such as a Storage Area Network (SAN), Network-Attached Storage (NAS), cloud-provisioned storage, or similar. Datastore 130 can be provided by a respective server or servers (not depicted). In at least one embodiment, datastore 130 is provided by server 140. Datastore 130 or its respective hardware can be centralized or decentralized. Examples of database applications that can correspond to datastore 130 include MongoDB, MySQL, MariaDB, DynamoDB, PostgreSQL, and others. Datastore 130 can partition data into various stores, buckets, tables, etc. based on the needs of the application(s) serviced by the datastore. In at least one embodiment, datastore 130 can store monolingual and/or multilingual STT training datasets, such as multilingual STT training dataset 132, for training monolingual and/or multilingual STT models.

Each of servers 140-170 can be a rackmount server, a router computer, a personal computer, a portable digital assistant, a mobile phone, a laptop computer, a tablet computer, a netbook, a desktop computer, a virtual machine (VM), a container, etc., or any combination of the above. The computer system of FIG. 5 can be an example of a server. In various embodiments, each of servers 140-170 can be several computing devices, such as multiple rackmount servers in a data center(s) or multiple VMs in a cloud platform. In at least one embodiment, functions provided by servers 140-170 can alternatively be provided by a single server.

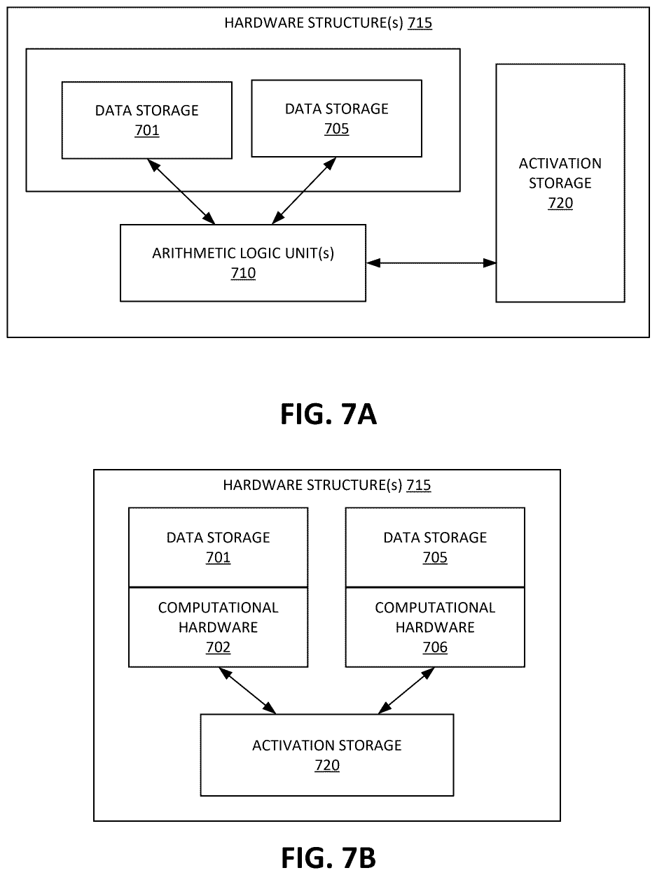

Server 140 includes STT model training service 142, which can be used to perform various operations associated with training or fitting STT models, such as data cleaning, data generation, data augmentation, regression, gradient calculations, backpropagation, loss calculations, or similar. For example, STT model training service 142 can train multilingual STT model 154 using multilingual STT training dataset 132 stored in datastore 130. Server 150 includes STT model inference service 152, which can be used to perform various operations associated with STT model inference, such as generative operations (e.g., sampling from a distribution), discriminative operations (e.g., classifying), and other types of operations. For example, STT model inference service 152 can perform inference on trained multilingual STT model 154. Example training and inference logic is further described with reference to FIGS. 7A-7B.

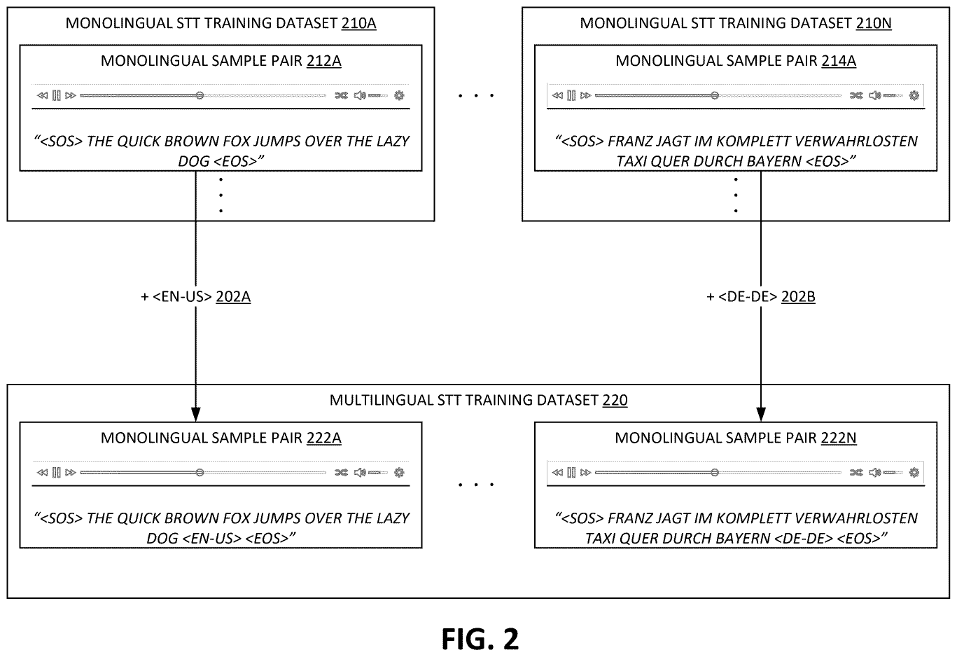

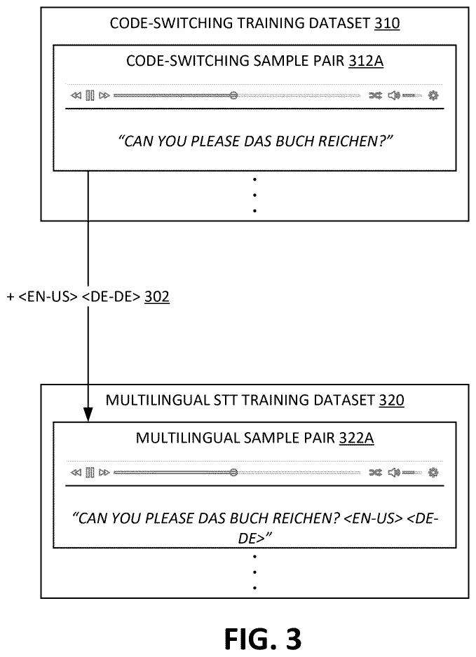

Multilingual STT model 154 can be a speech-to-text machine learning model that is trained to recognize and transcribe multiple languages into text. Multilingual STT model 154 is further trained to label the transcribed text with the relevant language using language indicators. The language indicators can be part of a predefined vocabulary of multilingual STT model 154 and can be distinct from any phoneme or grapheme. The use and placement of language indicators can be learned from the structure of multilingual STT training dataset 132, which is further described with reference to FIGS. 2-3. Various model architectures can be used for multilingual STT model 154 in various embodiments. For example, multilingual STT model 154 can be or can include transformers (e.g., encoder-decoder, encoder-only, decoder-only), recurrent neural networks (e.g., LSTMs), convolutional neural networks, hidden Markov models, or similar. In at least one embodiment, the architecture of multilingual STT model 154 can be suitable for either monolingual STT models (e.g., without the language indicators in a respective vocabulary) or for multilingual STT models as described herein (e.g., with the language indicators in a respective vocabulary). Thus, STT model training logic described with reference to datastore 130, server 140, and FIGS. 7A-7B can be effectively used or reused for training both monolingual STT models and multilingual STT model 154.

Server 160 includes language model training and/or inference service 162, which can be used to perform training or inference on one or more language models, such as language models 164A-164N. Although depicted as being performed by a single server/service, training and inference can be divided between multiple servers/services in at least one embodiment. Similarly, different servers/services can be used for training and/or performing inference on different language models.

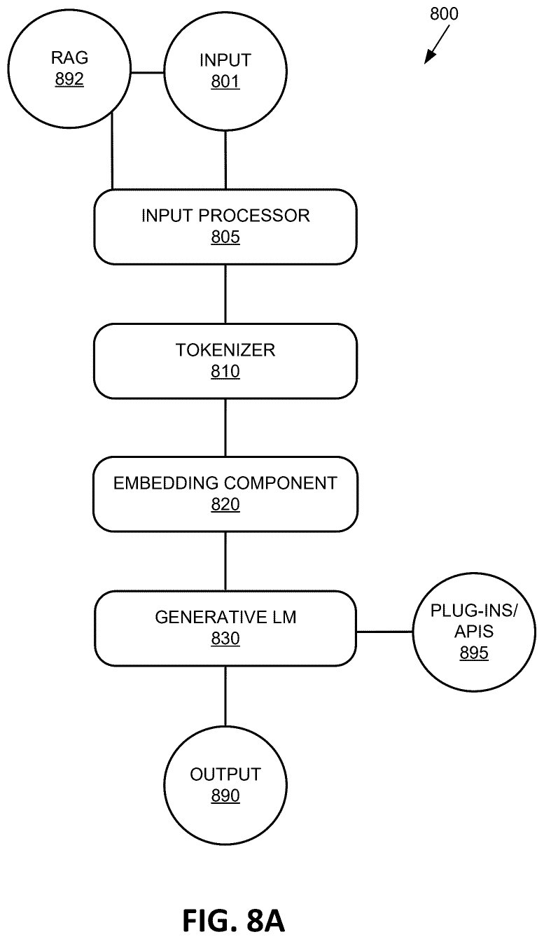

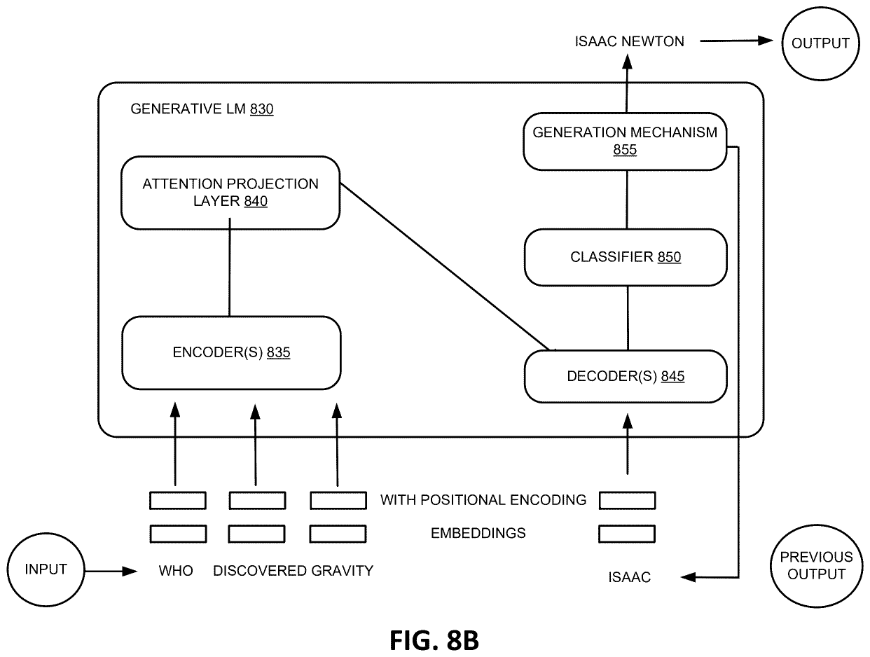

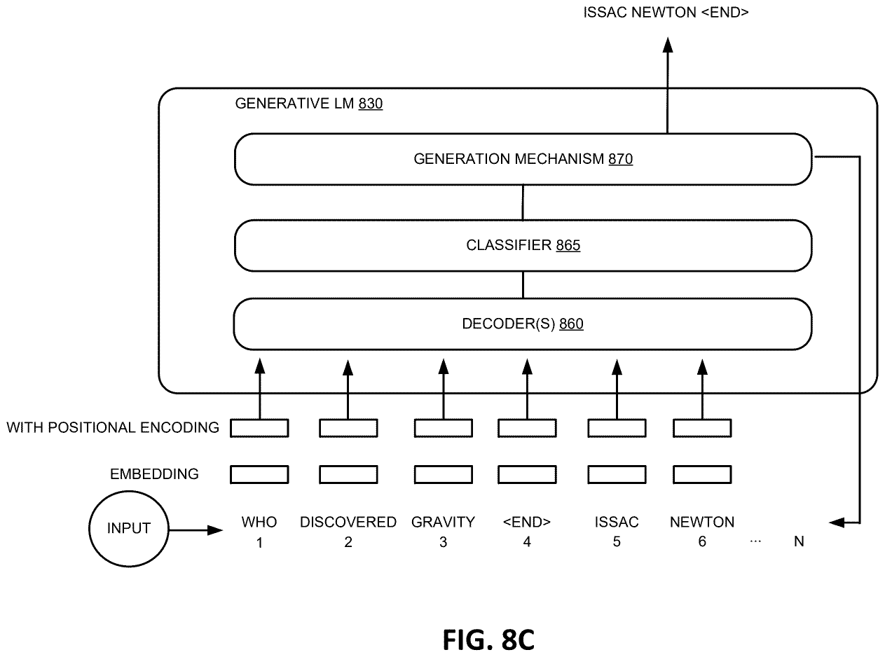

A language model of language models 164A-164N can be a machine learning model trained to perform one or more language-related tasks on textual output generated by an STT model or another component of an ASR pipeline. For example, a language model can be trained to correct low-probability transcriptions by correcting nonsensical sequences of grammatical units (e.g., graphemes, words, etc.) to sensical sequences. In another example, a language model can be trained to add or correct textual cues such as capitalization and punctuation. A language model can be monolingual, bilingual, or multilingual in various embodiments. A language model can be trained using a respective monolingual, bilingual, or multilingual training dataset. Examples of some types of language models that can be used are further described with reference to FIGS. 8A-8C.

Server 170 includes inverse text normalization service 172, which can be used to perform inverse text normalization on transcripts using one or more of ITN engines 174A-174N. Although depicted as being performed by a single server/service, different servers/services can be used for performing ITN with different ITN engines.

An ITN engine of ITN engines 174A-174N can be a machine learning model, a set of rules, or other structure trained/constructed to perform one or more inverse text normalization tasks on textual output generated by an STT model, language model, or another component of an ASR pipeline. For example, an ITN engine can be trained/constructed to convert the text “one hundred twenty-three” to “123,” “doctor” to “Dr.,” or similar. An ITN engine can be monolingual, bilingual, or multilingual in various embodiments.

Although the ASR pipeline of system 100 is depicted as having three components (multilingual speech-to-text, language models, and inverse text normalization), other embodiments can have more or fewer components than those depicted. For example, one embodiment can exclude inverse text normalization. In another example, and embodiment can include additional stages/components for removing background noise, isolating a speaker's voice among other voices, or similar.

FIG. 1B is a block diagram of an example architecture for multilingual STT model 154, in accordance with at least one embodiment. Multilingual STT model 154 can include an encoder layer 182 for receiving an acoustic speech signal 180 and generating acoustic embeddings. Encoder layer 182 can be, for example, a Conformer or FastConformer architecture. The acoustic embeddings can be provided to a decoder layer 184 to predict multilingual text tokens 186A, multilingual punctuation tokens 186B, and/or language indicators 186C. Tokens 186A-C can be part of a multilingual vocabulary 188. Multilingual vocabularies and tokens are further described with reference to FIGS. 2-3. In at least one embodiment, multilingual STT model 154 can be trained (e.g., by training service 142) using Connectionist Temporal Classification (CTC) loss, RNN Transducer (RNNT) loss, or other loss function.

FIG. 2 illustrates a multilingual STT training dataset 220 generated from a plurality of monolingual STT training datasets 210A-210N, in accordance with at least one embodiment. Monolingual STT training datasets 210A-210N can be existing training datasets that can be used to train monolingual STT models. Monolingual STT training datasets 210A-210N can be combined along with language indicators to generate multilingual STT training dataset 220, which can be used to train multilingual STT models as described herein (e.g., multilingual STT model 154 of FIG. 1). In at least one embodiment, multilingual STT training dataset 220 is multilingual STT training set 132 of FIG. 1.

A monolingual STT training dataset, such as monolingual STT training dataset 210A, can be associated with a single language and/or dialect. For example, monolingual STT training dataset 210A can be associated with the English language or the US English dialect. Monolingual STT training dataset 210A can include one or more training sample pairs, such as monolingual sample pair 212A. Monolingual sample pair 212A includes an audio sample and a corresponding textual transcript, such as the sentence, “the quick brown fox jumps over the lazy dog.” Grammatical units of the textual transcript can be encoded using a monolingual vocabulary. For example, graphemes, morphemes, words, or similar can be coded as integers, vectors in an embedding space, or similar. The vocabulary can include additional non-textual tokens, such as the depicted start-of-sentence <sos> and end-of-sentence <eos> indicators. The vocabulary can include punctuation marks, which can supplement or replace the non-textual tokens (compare, e.g., the <sos> and <eos> indicators of FIG. 2 with the punctuation marks of FIG. 3). Vocabularies can differ between monolingual STT training datasets. For example, monolingual STT training dataset 210A can use an English vocabulary, while monolingual STT training dataset 210N can use a German vocabulary. Vocabularies can be the same for different sample pairs within a training dataset. For example, all sample pairs in training dataset 210A can use an English vocabulary.

A multilingual STT training dataset, such as multilingual STT training dataset 220, can be associated with multiple languages and/or dialects. For example, multilingual STT training dataset 220 can be associated with English and German (and/or respective dialects). Multilingual STT training dataset 220 can include one or more training sample pairs, such as monolingual sample pairs 222A-222N. As described with reference to monolingual sample pair 212A, each training sample pair can include an audio sample and a corresponding textual transcript. In contrast to monolingual STT training datasets 210A-N, multilingual STT training dataset 220 and associated sample pairs can be associated with a multilingual vocabulary, which can include graphemes, morphemes, words, etc. from multiple languages and/or dialects. A multilingual vocabulary can further include multilingual punctuation, capital/lowercase characters, and other language-specific features. Each sample pair can be associated with a subset of the multilingual vocabulary corresponding to a single language or dialect, such as English (sample pair 222A) or German (sample pair 222N). The vocabulary can further include additional non-textual tokens for indicating a language associated with a grammatical unit. As depicted, language indicators such as <en-US> for English (US) and <de-DE> for German (Germany) can be located at the end of a sentence (e.g., prior to the <eos> indicator). In various embodiments, language indicators can be located at the beginning, end, and/or other location with respect to grammatical units such as graphemes, words, sentences, paragraphs, etc. In another embodiment, language indicators can be located at a boundary between different languages.

To generate multilingual STT training dataset 220, monolingual STT training datasets 210A-210N can be augmented and combined. Augmenting training datasets can include adding language indicators to sample pairs of each training dataset, as depicted in operations 202A-202B. Augmenting training datasets can further include reencoding sample transcripts from their respective monolingual vocabularies to a language indicator-enhanced multilingual vocabulary of the multilingual training dataset. Other types of dataset augmentation can be used in various embodiments. The augmented sample pairs can thus be combined to form a joint multilingual STT training dataset with a single multilingual vocabulary.

FIG. 3 illustrates a multilingual STT training dataset 320 generated from a code-switching training dataset 310, in accordance with at least one embodiment. Code-switching training dataset 310 includes one or more code-switching sample pairs, such as code-switching sample pair 312A. Aspects described with reference to sample pairs in FIG. 2 can similarly apply to code switching sample pair 312A. For example, sample pair 312A can be associated with a vocabulary that includes a plurality of languages involved in code switching (e.g., English and German). The vocabulary can further include punctuation marks and/or non-textual tokens (e.g., FIG. 3 depicts a question mark, whereas FIG. 2 depicts <sos> and <eos> indicators).

To generate multilingual STT training dataset 320 from code-switching training dataset 310, a plurality of language indicators can be added to sample pair 312A at operation 302 to form multilingual sample pair 322A. Each language indicator of the plurality of language indicators can indicate a language that is present in the referent code-switched grammatical unit (e.g., a sentence in the case of FIG. 3). In various embodiments, as described with reference to FIG. 2, language indicators can be located in various locations with respect to the referent grammatical unit, such as at the beginning or end of a sentence, before or after a punctation mark or non-textual token, or similar.

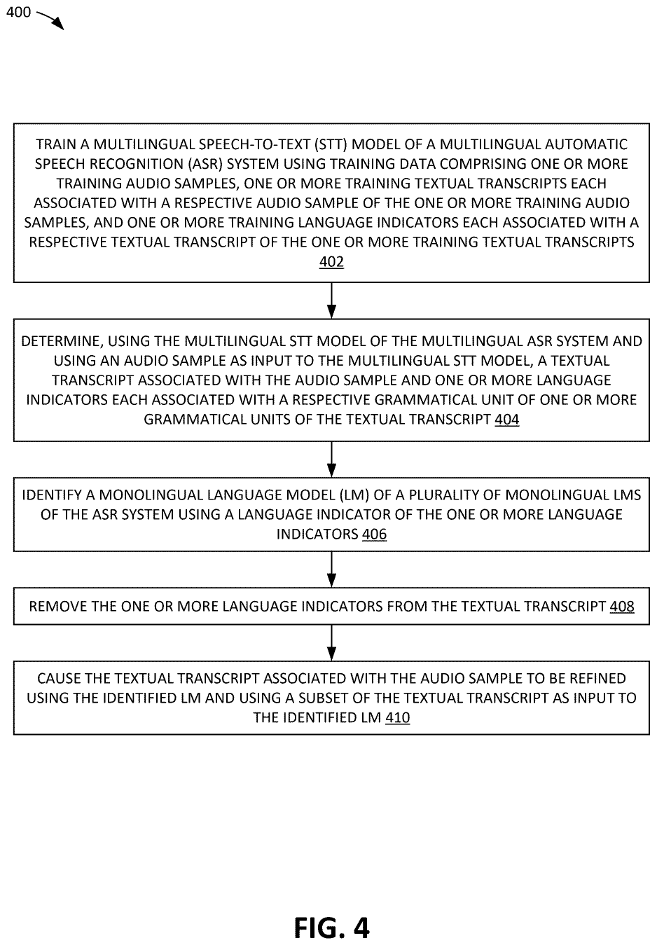

FIG. 4 is a flow diagram of an example method 400 for a multilingual automatic speech recognition pipeline using a multilingual speech-to-text model and language indicators, in accordance with at least one embodiment. Method 400 can be performed by processing logic that can comprise hardware (e.g., circuitry, dedicated logic, etc.), computer-readable instructions such as software or firmware (e.g., run on a general-purpose computing system or a dedicated machine), or a combination thereof. For instance, an example system can include a memory and a processing device coupled to the memory device to perform operations comprising the blocks of method 400. Method 400 can also be associated with a set of instructions stored on a non-transitory computer-readable medium (e.g., magnetic or optical disk, etc.). The instructions, when executed by a processing device, can cause the processing device to perform operations comprising the blocks of method 400. In at least one embodiment, method 400 is performed by one or more of servers 140-170 or client devices 120A-120N of FIG. 1A, or components thereof. In at least one embodiment, method 400 is performed by computing system 500 of FIG. 5. In some embodiments, blocks depicted in FIG. 4 could be performed simultaneously or in a different order than depicted. Various embodiments can include additional blocks not depicted in FIG. 4 or a subset of blocks depicted in FIG. 4.

At block 402, processing logic trains a multilingual STT model of a multilingual ASR system using training data comprising one or more training audio samples, one or more training textual transcripts each associated with a respective audio sample of the one or more training audio samples, and one or more training language indicators each associated with a respective textual transcript of the one or more training textual transcripts. The multilingual STT model can be multilingual STT model 154 of ASR system 100 and can be trained by STT model training service 142. The training data can be multilingual STT training datasets 132, 220, and/or 320. As described with reference to FIG. 2, the training data can include one or more sample pairs (e.g., sample pairs 222A-222N), each including a training audio sample and a training textual transcript. The training transcript of each pair can include one or more language indicators denoting the language(s) and/or dialects present in the audio-transcript pair, such as <en-US> or <de-DE>. The multilingual STT model can be associated with a multilingual vocabulary (e.g., multilingual vocabulary 188), which can include the one or more language indicators. Example training and inference logic is further described with reference to FIGS. 7A-7B. In at least one embodiment, a model architecture of the multilingual STT model corresponds to (e.g., is the same as) a model architecture of a monolingual STT model and can be trained using the same training infrastructure (e.g., training service 142) as the monolingual STT model with multilingual training data.

At block 404, the processing logic determines, using the multilingual STT model of the multilingual ASR system and using an audio sample as input to the multilingual STT model, a textual transcript associated with the audio sample and one or more language indicators each associated with a respective grammatical unit of one or more grammatical units of the textual transcript. The audio sample can be speech signal 180 of FIG. 1B, and the textual transcript can include multilingual text tokens 186A and multilingual punctuation tokens 186B. The language indicators can be language indicators 186C. The processing logic can determine the textual transcript and language indicators by performing inference on the multilingual STT model, such as by using STT model inference service 152 and obtaining the textual transcript and language indicators as output of the multilingual STT model. In at least one embodiment, the determining can be based at least on a multilingual STT model processing audio data corresponding to an audio sample.

In at least one embodiment, the one or more grammatical units of the textual transcript are sentences, and the one or more language indicators are each located following a punctuation mark or end-of-sentence token of a respective sentence. In other embodiments, the grammatical units can be graphemes, morphemes, words, clauses, paragraphs, etc., and the language indicators can be located before and/or after the grammatical units or their respective punctuation.

In at least one embodiment, two language indicators of the one or more language indicators are each associated with a code-switched grammatical unit of the one or more grammatical units of the textual transcript. In at least one embodiment, the code-switched grammatical unit is a sentence, and the two language indicators are located following a punctuation mark of the sentence (e.g., as depicted in FIG. 3).

At block 406, the processing logic identifies a monolingual LM of a plurality of monolingual LMs of the ASR system using a language indicator of the one or more language indicators. The plurality of monolingual LMs can be LMs 164A-164N of FIG. 1. The processing logic can identify a monolingual LM which is trained for a language that matches a language denoted by the language indicator. For example, the processing logic can select an English LM based on a <en-US> token in the transcript.

At block 408, the processing logic removes the one or more language indicators from the textual transcript. Subsequent to identifying the relevant LM(s), the language indicators may no longer be used in the ASR pipeline. Furthermore, the language indicators may not be in the vocabulary of the identified language model. Thus, the processing logic can remove the language indicators from the textual transcript before providing the transcript to the LM or other post-processing component (e.g., ITN engine). In at least one embodiment, the processing logic can further convert (e.g., reencode) the textual transcript from a multilingual vocabulary of the STT model to a monolingual vocabulary of the identified LM.

At block 410, the processing logic causes the textual transcript associated with the audio sample to be refined using the identified LM and using a subset of the textual transcript as input to the identified LM. The processing logic can cause another server/service (e.g., LM training/inference service 162) to refine the textual transcript using the identified LM. The subset of the textual transcript can be the textual transcript without the one or more language indicators (e.g., as removed at block 408). Refining the textual transcript can include correcting syntactic or semantic errors (e.g., grammatical errors or nonsensical phrases). In at least one embodiment, the processing logic causes the textual transcript to be refined using other monolingual post-processing components, such as a monolingual ITN engine. In at least one embodiment, the processing logic determines, based at least on a monolingual LM processing at least a portion of the transcript and an associated language indicator of the one or more language indicators, an updated textual transcript.

In at least one embodiment, the processing logic performs one or more operations using the updated textual transcript. The one or more operations can include causing presentation of at least a portion of the updated textual transcript using one or more display devices of the system; translating at least a portion of the updated textual transcript to another language and causing display using the one or more display devices; or translating at least a portion of the updated textual transcript to another language and causing audio output using a synthetic voice corresponding to the portion of the update textual transcript.

In at least one embodiment, processing logic generating a final textual transcript corresponding to an audio segment based at least on a multi-lingual language model processing the audio segment to generate an initial textual transcript including one or more language indicators and one or more monolingual language models processing the initial textual transcript and the one or more language indicators to generate the final textual transcript. In at least one embodiment, the processing logic removes the one or more language indicators from the initial textual transcript during the generating of the final textual transcript. In at least one embodiment, the processing logic trains the multilingual language model using training data comprising one or more second audio segments, one or more second textual transcripts each associated with a respective audio segment of the one or more second audio segments, and one or more second language indicators each associated with a respective textual transcript of the one or more second textual transcripts. In at least one embodiment, the final textual transcript is one of stored on a device, visually presented on a device, or used to generate a synthetic audio output using a device. In at least one embodiment, the initial textual transcript includes two different language indicators corresponding to a code switch within the audio segment, and the final textual transcript is generated using a first monolingual language model corresponding to a first language in the initial textual transcript and a second monolingual language model corresponding to a second language in the initial textual transcript. In at least one embodiment, the processing logic is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

In some examples, the machine learning model(s) (e.g., STT models, language models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container).

In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring.

In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., STT model, language model, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., STT models, language models, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., STT models, language models, etc.) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., STT models, language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., STT models, language models, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)-which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., STT models, language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

FIG. 5 is a block diagram of an example computing device(s) 500 suitable for use in implementing some embodiments of the present disclosure. For example, computing device 500 can correspond to one or more of client devices 120A-120N and/or servers 140-170 of FIG. 1A. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

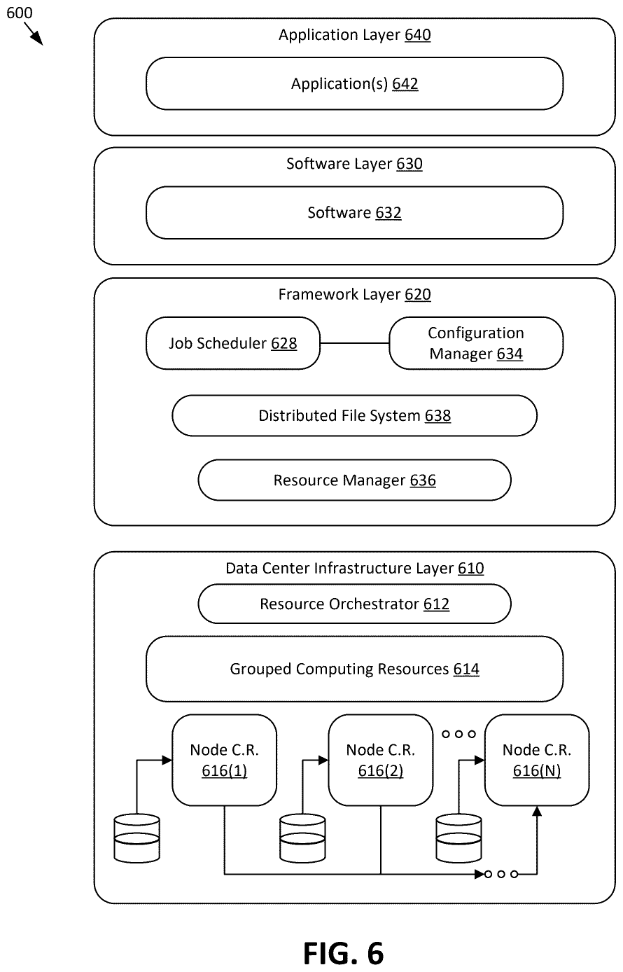

FIG. 6 illustrates an example data center 600 that may be used in at least one embodiments of the present disclosure. For example, data center 600 can include one or more of servers 140-170 of FIG. 1A. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache SparkTM (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

FIG. 7A illustrates inference and/or training logic 715 used to perform inferencing and/or training operations associated with one or more embodiments. For example, inference and/or training logic can be used to train and/or perform inference on multilingual STT model 154 and/or LMs 164A-164N of FIG. 1A. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as data processing unit (“DPU”) hardware, or field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as data processing unit (“DPU”) hardware, or field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types. In at least one embodiment, LMs 164A-164N of FIG. 1 are LLMs, VLMs, MMLMs, or similar.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 8A is a block diagram of an example generative language model system 800 suitable for use in implementing at least some embodiments of the present disclosure. In the example illustrated in FIG. 8A, the generative language model system 800 includes a retrieval augmented generation (RAG) component 892, an input processor 805, a tokenizer 810, an embedding component 820, plug-ins/APIs 895, and a generative language model (LM) 830 (which may include an LLM, a VLM, a multi-modal LM, etc.).

At a high level, the input processor 805 may receive an input 801 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 830 (e.g., LLM/VLM/MMLM/etc.). In some embodiments, the input 801 includes plain text in the form of one or more sentences, paragraphs, and/or documents. Additionally or alternatively, the input 801 may include numerical sequences, precomputed embeddings (e.g., word or sentence embeddings), and/or structured data (e.g., in tabular formats, JSON, or XML). In some implementations in which the generative LM 830 is capable of processing multi-modal inputs, the input 801 may combine text (or may omit text) with image data, audio data, video data, design data, USD data, and/or other types of input data, such as but not limited to those described herein. Taking raw input text as an example, the input processor 805 may prepare raw input text in various ways. For example, the input processor 805 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 805 may remove stopwords to reduce noise and focus the generative LM 830 on more meaningful content. The input processor 805 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 892 (which may include one or more RAG models, and/or may be performed using the generative LM 830 itself) may be used to retrieve additional information to be used as part of the input 801 or prompt. RAG may be used to enhance the input to the LLM/VLM/MMLM/etc. with external knowledge, so that answers to specific questions or queries or requests are more relevant—such as in a case where specific knowledge is required. The RAG component 892 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 801 may be generated using the query or input to the model (e.g., a question, a request, etc.) in addition to data retrieved using the RAG component 892. In some embodiments, the input processor 805 may analyze the input 801 and communicate with the RAG component 892 (or the RAG component 892 may be part of the input processor 805, in embodiments) in order to identify relevant text and/or other data to provide to the generative LM 830 as additional context or sources of information from which to identify the response, answer, or output 890, generally. For example, where the input indicates that the user is interested in a desired tire pressure for a particular make and model of vehicle, the RAG component 892 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 892 may retrieve a prior stored conversation history—or at least a summary thereof—and include the prior conversation history along with the current ask/request as part of the input 801 to the generative LM 830.

The RAG component 892 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 892 and the embeddings of the chunks along with the embeddings of the query may be compared to identify the most similar/related embeddings to the query, which may be supplied to the generative LM 830 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 892 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 810 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 830 to understand morphological variations and handle out-of-vocabulary words more effectively. Character-based tokenization represents each character as a separate token, enabling the generative LM 830 to process text at a fine-grained level. The choice of tokenization strategy may depend on factors such as the language being processed, the task at hand, and/or characteristics of the training dataset. As such, the tokenizer 810 may convert the (e.g., processed) text into a structured format according to tokenization schema being implemented in the particular embodiment.

The embedding component 820 may use any known embedding technique to transform discrete tokens into (e.g., dense, continuous vector) representations of semantic meaning. For example, the embedding component 820 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 801 includes image data/video data/etc., the input processor 801 may resize the data to a standard size compatible with format of a corresponding input channel and/or may normalize pixel values to a common range (e.g., 0 to 1) to ensure a consistent representation, and the embedding component 820 may encode the image data using any known technique (e.g., using one or more convolutional neural networks (CNNs) to extract visual features). In some implementations in which the input 801 includes audio data, the input processor 801 may resample an audio file to a consistent sampling rate for uniform processing, and the embedding component 820 may use any known technique to extract and encode audio features—such as in the form of a spectrogram (e.g., a mel-spectrogram). In some implementations in which the input 801 includes video data, the input processor 801 may extract frames or apply resizing to extracted frames, and the embedding component 820 may extract features such as optical flow embeddings or video embeddings and/or may encode temporal information or sequences of frames. In some implementations in which the input 801 includes multi-modal data, the embedding component 820 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 830 and/or other components of the generative LM system 800 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 820 may apply an encoded representation of the input 801 to the generative LM 830, and the generative LM 830 may process the encoded representation of the input 801 to generate an output 890, which may include responsive text and/or other types of data.

As described herein, in some embodiments, the generative LM 830 may be configured to access or use—or capable of accessing or using—plug-ins/APIs 895 (which may include one or more plug-ins, application programming interfaces (APIs), databases, data stores, repositories, etc.). For example, for certain tasks or operations that the generative LM 830 is not ideally suited for, the model may have instructions (e.g., as a result of training, and/or based on instructions in a given prompt, such as those retrieved using the RAG component 892) to access one or more plug-ins/APIs 895 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 895 to the plug-in/API 895, the plug-in/API 895 may process the information and return an answer to the generative LM 830, and the generative LM 830 may use the response to generate the output 890. This process may be repeated—e.g., recursively—for any number of iterations and using any number of plug-ins/APIs 895 until an output 890 that addresses each ask/question/request/process/operation/etc. from the input 801 can be generated. As such, the model(s) may not only rely on its own knowledge from training on a large dataset(s) and/or from data retrieved using the RAG component 892, but also on the expertise or optimized nature of one or more external resources—such as the plug-ins/APIs 895.

FIG. 8B is a block diagram of an example implementation in which the generative LM 830 includes a transformer encoder-decoder. For example, assume input text such as “Who discovered gravity” is tokenized (e.g., by the tokenizer 810 of FIG. 8A) into tokens such as words, and each token is encoded (e.g., by the embedding component 820 of FIG. 8A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 835 of the generative LM 830.

In an example implementation, the encoder(s) 835 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 840 may convert the context vector into attention vectors (keys and values) for the decoder(s) 845.

In an example implementation, the decoder(s) 845 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 835, in an example transformer architecture, each token (e.g., word) flows through a separate path in the decoder(s) 845. During a first pass, the decoder(s) 845, a classifier 850, and a generation mechanism 855 may generate a first token, and the generation mechanism 855 may apply the generated token as an input during a second pass. The process may repeat in a loop, successively generating and adding tokens (e.g., words) to the output from the preceding pass and applying the token embeddings of the composite sequence with positional encodings as an input to the decoder(s) 845 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 835, except that it creates its queries from the layer below it and takes the keys and values (e.g., matrix) from the output of the encoder(s) 835.

As such, the decoder(s) 845 may output some decoded (e.g., vector) representation of the input being applied during a particular pass. The classifier 850 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 855 may select or sample a word or token based on a corresponding predicted probability (e.g., select the word with the highest predicted probability) and append it to the output from a previous pass, generating each word or token sequentially. The generation mechanism 855 may repeat the process, triggering successive decoder inputs and corresponding predictions until selecting or sampling a symbol or token that represents the end of the response, at which point, the generation mechanism 855 may output the generated response.

FIG. 8C is a block diagram of an example implementation in which the generative LM 830 includes a decoder-only transformer architecture. For example, the decoder(s) 860 of FIG. 8C may operate similarly as the decoder(s) 845 of FIG. 8B except each of the decoder(s) 860 of FIG. 8C omits the encoder-decoder self-attention layer (since there is no encoder in this implementation). As such, the decoder(s) 860 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 860. As with the decoder(s) 845 of FIG. 8B, each token (e.g., word) may flow through a separate path in the decoder(s) 860, and the decoder(s) 860, a classifier 865, and a generation mechanism 870 may use auto-regression to sequentially generate one token at a time until predicting a symbol or token that represents the end of the response. The classifier 865 and the generation mechanism 870 may operate similarly as the classifier 850 and the generation mechanism 855 of FIG. 8B, with the generation mechanism 870 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

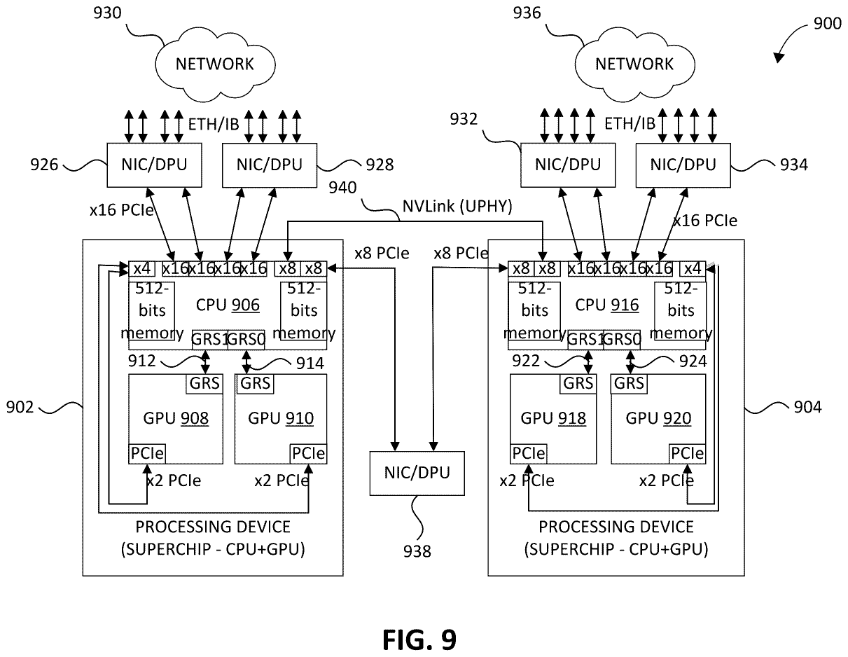

FIG. 9 is a block diagram of a computing system 900 having two processing devices coupled to each other and multiple networks according to at least one embodiment. The computing system 900 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 900. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 900 highly suitable for demanding applications that require significant processing power, such as artificial intelligence (AI), machine learning (ML), and data-intensive computing, while ensuring robust connectivity and scalability across various networked environments. The integrated circuits of the computing system 900 can include one or more CPUs and one or more GPUs. An example architecture of a multi-GPU architecture is illustrated in FIG. 9.

As illustrated in FIG. 9, the computing system 900 includes a processing device 902 with a multi-GPU architecture. In particular, the processing device 902 includes a CPU 906, a GPU 908, and a GPU 910. The CPU 906 can be coupled to the GPU 908 via an die-to-die (D2D) or chip-to-chip (C2C) interconnect 912, such as a Ground-Referenced Signaling interconnect (GRS interconnect). The CPU 906 can be coupled to the GPU 910 via a D2D or C2C interconnect 914. The CPU 906 can also couple to the GPU 908 and GPU 910 via PCIe interconnects. The CPU 906 can be coupled to one or more network interface cards (NICs) or data processing units (DPUs), which are coupled to one or more networks. For example, as illustrated in FIG. 9, the CPU 906 is coupled to a first NIC/DPU 926, which is coupled to a network 930. The CPU 906 is also coupled to a second NIC/DPU 928, which is coupled to the network 930. The NIC/DPU 926 and NIC/DPU 928 can be coupled to the network 930 over Ethernet (ETH) or InfiniBand (IB) connections.

The computing system 900 also includes a processing device 904 with a multi-GPU architecture. In particular, the processing device 904 includes a CPU 916, a GPU 918, and a GPU 920. The CPU 916 can be coupled to the GPU 918 via an D2D or C2C interconnect 922. The CPU 916 can be coupled to the GPU 920 via a D2D or C2C interconnect 924. The CPU 916 can also couple to the GPU 918 and GPU 920 via PCIe interconnects. The CPU 916 can be coupled to one or more NICs or DPUs, which are coupled to one or more networks. For example, as illustrated in FIG. 9, the CPU 916 is coupled to a first NIC/DPU 932, which is coupled to a network 936. The CPU 916 is also coupled to a second NIC/DPU 934, which is coupled to the network 936. The NIC/DPU 932 and NIC/DPU 934 can be coupled to the network 936 over Ethernet (ETH) or InfiniBand (IB) connections.

In at least one embodiment, the processing device 902 and the processing device 904 can communication with each other via a NIC/DPU 938, such as over PCIe interconnects. The processing device 902 and processing device 904 can also communicate with each other over a high-bandwidth communication interconnects 940, such as an NVLink interconnect or other high-speed interconnects.

In at least one embodiment, the computing system 900 is used for high-speed network communication and includes a processing unit (e.g., CPU 906, GPU 908, GPU 910, CPU 916, GPU 918, GPU 920, NIC/DPU 926, NIC/DPU 928, NIC/DPU 932, NIC/DPU 934, or NIC/DPU 938) and a network interface coupled to the processing unit. The processing unit and network interface can be used to implement a multilingual automatic speech recognition pipeline using a multilingual speech-to-text model and language indicators, such as by performing the operations of FIG. 4, training various machine learning models (e.g., STT models, LM models, etc.), or similar.

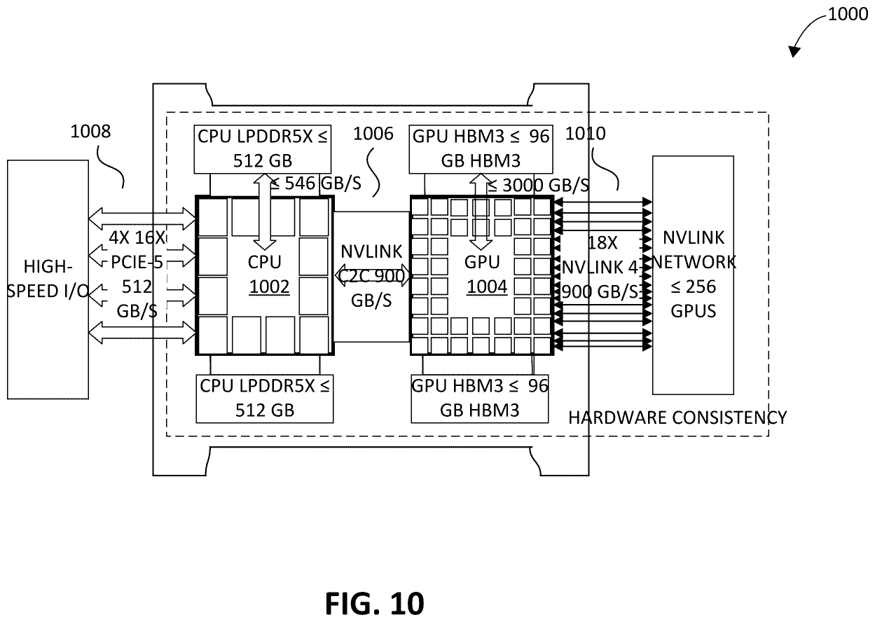

FIG. 10 is a block diagram of a computing system 1000 having a CPU 1002 and a GPU 1004 in a single integrated circuit according to at least one embodiment. The computing system 1000 can be a highly integrated design where a CPU 1002 and GPU 1004 are connected on a single integrated circuit, utilizing an NVLink C2C (Chip-to-Chip) interconnect 1006 to enable fast, low-latency communication between the two processing units. This close integration allows for efficient data transfer and parallel processing between the CPU 1002 and GPU 1004, optimizing performance for complex computational tasks. The GPU elements within the computing system 1000 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 1010. Additionally, the computing system 1000 can be designed to interface with a high-speed I/O through PCIe interconnects 1008, ensuring rapid data transfer to and from external devices, further enhancing the system's capabilities in handling data-intensive tasks and providing robust connectivity to peripheral components. It should be noted that the C2C interconnects 1006 can be considered D2D interconnects since the CPU 1002 and the GPU 1004 are located on the same integrated circuit. The integrated circuit can include CPU memory (also referred to as main memory) and GPU memory, which are accessible by the CPU 1002 and the GPU 1004, respectively, over high-speed interconnects. The computing system 1000 can bring together performance of the GPU 1004 with the versatility of the CPU 1002. The CPU 1002 can be connected with a high-bandwidth and memory coherent C2C interconnects 1006 in a single integrated circuit. The computing system 1000 can support a link switch system.

In at least one embodiment, the computing system 1000 is used for high-speed network communication and includes a processing unit (e.g., CPU 1002, GPU 1004, NVLink network) and a network interface coupled to the processing unit. The processing unit and network interface can be used to implement a multilingual automatic speech recognition pipeline using a multilingual speech-to-text model and language indicators, such as by performing the operations of FIG. 4, training various machine learning models (e.g., STT models, LM models, etc.), or similar.

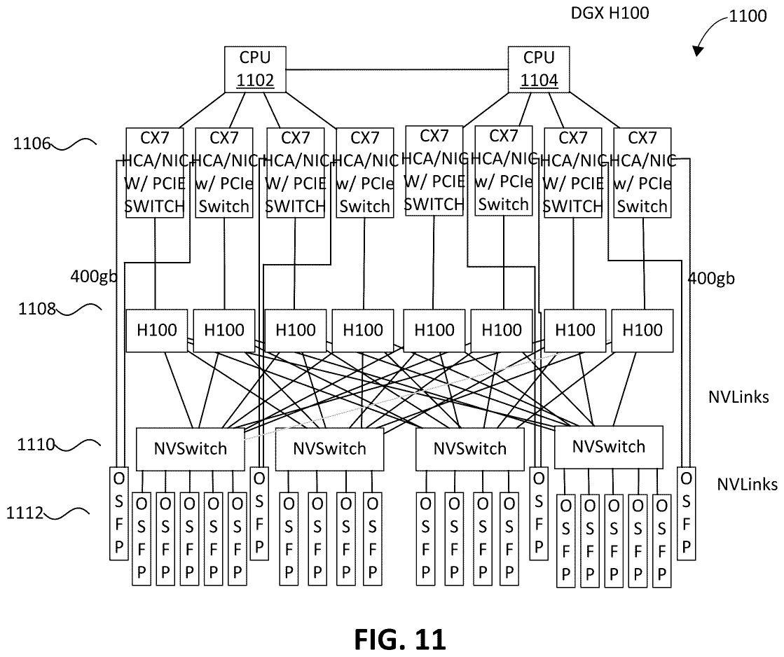

FIG. 11 is a block diagram of a computing system 1100 having tensor core GPUs 1108 according to at least one embodiment. The computing system 1100 can be a DGX H100 system, which is a high-performance computing platform designed to meet the demands of AI, ML, and deep learning (DL) workloads. The computing system 1100 can include multiple tensor core GPUs 1108 (e.g., NVIDIA H100 Tensor Core GPUs). The tensor core GPUs 1108 can each be one of the integrated circuits described above with respect to FIG. 10. The tensor core GPUs 1108 can be optimized for AI/ML/DL applications, offering exceptional performance for deep learning training, inference, and high-performance computing tasks. The tensor core GPUs 1108 within the computing system 1100 are interconnected using high-speed communication interfaces like NVLinks, enabling rapid data transfer between them, which is crucial for handling large-scale AI models and datasets with low latency. This computing system 1100 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1108, the computing system 1100 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1108 for their specific applications. The computing system 1100 is ideally suited for large-scale AI model training, real-time inference, scientific simulations, data analytics, and other compute-intensive tasks that require massive parallel processing power.

The tensor core GPUs 1108 can be coupled to multiple CPUs, such as CPU 1102 and CPU 1104, using switches 1106 (e.g., CX7 HCA/NIC with PCIe switch). The tensor core GPUs 1108 can be coupled to each other via switches 1110 (e.g., NVSwitches). The switches 1106 and switches 1110 can be coupled to high-speed transceiver modules 1112. The high-speed transceiver modules 1112 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1100 remains capable of meeting increasing data demands and can be upgraded to support future advancements in network speeds, thus contributing to the system's overall performance and scalability.

In at least one embodiment, the computing system 1100 can be considered a data-network configuration with full-bandwidth intra-server NVLinks. In this example, all eight tensor core GPUs 1108 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1108 can half-subscribe eighteen NVLinks to GPUs in other servers. Four tensor core GPUs 1108 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1108 can independently transfer data, using Remote Direct Memory Access (RDMA) protocol, over its own dedicated switch (e.g., 400 Gb/s HCA/NIC) in a multi-rail InfiniBand/Ethernet configuration. In this example, 800 GBps of aggregate full-duplex to non-NVLink network devices.

In at least one embodiment, the computing system 1100 is used for high-speed network communication and includes a processing unit (e.g., CPU 1102, CPU 1102, switches 1106, tensor core GPUs 1108, switches 1110, high-speed transceiver modules 1112) and a network interface coupled to the processing unit. The processing unit and network interface can be used to implement a multilingual automatic speech recognition pipeline using a multilingual speech-to-text model and language indicators, such as by performing the operations of FIG. 4, training various machine learning models (e.g., STT models, LM models, etc.), or similar.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure, and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still CO-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As a non-limiting example, a “processor” may be a network device. A “computing platform” may comprise one or more processors. As used herein, “software” processes may include, for example, software and/or hardware entities that perform work over time, such as tasks, threads, and intelligent agents. Also, each process may refer to multiple processes for continuously or intermittently carrying out instructions in sequence or in parallel. In at least one embodiment, the terms “system” and “method” are used herein interchangeably as far as the system may embody one or more methods and methods may be considered a system.

In the present document, references may be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
determining, using a multilingual speech-to-text (STT) model of a multilingual automatic speech recognition (ASR) system and using an audio sample as input to the multilingual STT model, a textual transcript associated with the audio sample and one or more language indicators each associated with a respective grammatical unit of one or more grammatical units of the textual transcript;
identifying a monolingual language model (LM) of a plurality of monolingual LMs of the ASR system using a language indicator of the one or more language indicators; and
causing the textual transcript associated with the audio sample to be refined using the identified LM and using a subset of the textual transcript as input to the identified LM.

2. The method of claim 1, further comprising:
removing the one or more language indicators from the textual transcript.

3. The method of claim 1, further comprising:
training the multilingual STT model using training data comprising one or more second audio samples, one or more second textual transcripts each associated with a respective audio sample of the one or more second audio samples, and one or more second language indicators each associated with a respective textual transcript of the one or more second textual transcripts.

4. The method of claim 1, wherein the one or more grammatical units of the textual transcript are sentences, and wherein the one or more language indicators are each located following a punctuation mark of a respective sentence.

5. The method of claim 1, wherein a multilingual vocabulary of the multilingual STT model comprises the one or more language indicators.

6. The method of claim 1, wherein a model architecture of the multilingual STT model corresponds to a model architecture of a monolingual STT model.

7. The method of claim 1, wherein two language indicators of the one or more language indicators are each associated with a code-switched grammatical unit of the one or more grammatical units of the textual transcript.

8. The method of claim 7, wherein the code-switched grammatical unit is a sentence, and wherein the two language indicators are located following a punctuation mark of the sentence.

9. A system comprising:
one or more processors to cause performance of operations comprising:
determining, based at least on a multilingual speech-to-text (STT) model processing audio data corresponding to an audio sample, a textual transcript associated with the audio sample and one or more language indicators each associated with a respective grammatical unit of one or more grammatical units of the textual transcript;
determining, based at least on a monolingual language model (LM) processing at least a portion of the transcript and an associated language indicator of the one or more language indicators, an updated textual transcript; and
performing one or more operations using the updated textual transcript.

10. The system of claim 9, the operations further comprising:
removing the one or more language indicators from the textual transcript prior to performing the one or more operations.

11. The system of claim 9, the operations further comprising:
training the multilingual STT model using training data comprising one or more second audio samples, one or more second textual transcripts each associated with a respective audio sample of the one or more second audio samples, and one or more second language indicators each associated with a respective textual transcript of the one or more second textual transcripts.

12. The system of claim 9, wherein the one or more operations include at least one of:
causing presentation of at least a portion of the updated textual transcript using one or more display devices of the system;
translating at least a portion of the updated textual transcript to another language and causing display using the one or more display devices; or
translating at least a portion of the updated textual transcript to another language and causing audio output using synthetic voice corresponding to the portion of the update textual transcript.

13. The system of claim 9, wherein a multilingual vocabulary of the multilingual STT model comprises the one or more language indicators.

14. The system of claim 9, wherein a model architecture of the multilingual STT model corresponds to a model architecture of a monolingual STT model.

15. One or more processors comprising processing circuitry to cause performance of operations comprising:
generating a final textual transcript corresponding to an audio segment based at least on a multi-lingual language model processing the audio segment to generate an initial textual transcript including one or more language indicators and one or more monolingual language models processing the initial textual transcript and the one or more language indicators to generate the final textual transcript.

16. The one or more processors of claim 15, the operations further comprising:
removing the one or more language indicators from the initial textual transcript during the generating of the final textual transcript.

17. The one or more processors of claim 15, the operations further comprising:
training the multilingual language model using training data comprising one or more second audio segments, one or more second textual transcripts each associated with a respective audio segment of the one or more second audio segments, and one or more second language indicators each associated with a respective textual transcript of the one or more second textual transcripts.

18. The one or more processors of claim 15, wherein the final textual transcript is one of stored on a device, visually presented on a device, or used to generate a synthetic audio output using a device.

19. The one or more processors of claim 15, wherein the initial textual transcript includes two different language indicators corresponding to a code switch within the audio segment, and the final textual transcript is generated using a first monolingual language model corresponding to a first language in the initial textual transcript and a second monolingual language model corresponding to a second language in the initial textual transcript.

20. The one or more processors of claim 15, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
